(19) United States
(12) Patent Application Publication
(10) Pub. No.: US 2005/0193182 A1
(43) Pub. Date: Sep. 1, 2005

(54) Method and apparatus for preventing un-authorized computer data access

(76) Inventors: Laurence G. Anderson, Aurora (CA); Jon Hykawy, Ajax (CA); Mitchell James H., Aurora (CA); Keith McNally, Uxbridge (CA)

Correspondence Address: ANISSIMOFF & ASSOCIATES;RICHMOND NORTH OFFICE CENTRE, SUITE 201, 235 NORTH CENTRE RD., LONDON, ON, N5X 4E7, CA

(21) Appl. No.: 11/055,688

(22) Filed: Feb. 11, 2005

Related U.S. Application Data
(60) Provisional application No. 60/544,701, filed on Feb. 12, 2004.

(51) Int. Cl. G06F 12/14

(52) U.S. Cl. 711/163; 711/112

(57) ABSTRACT

An apparatus and method of preventing unauthorized access to computer data. The apparatus is installed in a computer system between the main board and an associated data storage device, for example a hard drive. Read/write commands from the motherboard to the hard drive are intercepted and scrutinized by a filter means of the apparatus. If the pre-determined level of data access of the user issuing the command is insufficient to permit the type of access that is being sought (eg: write access is sought, but the user only has permission for read access on that particular hard drive partition), then the command is blocked. An identity means, for example an RFID, may also be included that identifies an authorized user and corresponding level of data access. The apparatus and method may be employed as a stand-alone solution or as part of a computer network.

### CROSS REFERENCE TO RELATED APPLICATIONS

This application claims the benefit of U.S. patent application 60/544,701, filed Feb. 12, 2004, which is hereby incorporated herein by reference.

### FIELD OF THE INVENTION

The invention broadly relates to computer hardware, software and controller systems, and more particularly, relates to a method and apparatus for filtering read/write commands to a data storage device to selectively block unauthorized data access.

### BACKGROUND OF THE INVENTION

Computer systems are well known in the art. These prior art computer systems comprise a main board, or motherboard, with other boards or devices connected thereto. Examples of these connected devices include data storage devices, such as hard disk drives, floppy disk drives, optical disk drives, or solid state memory. Hard disk drives in particular are used for rapid data storage and retrieval and communicate with the motherboard using a variety of protocols, for example, IDE, Serial ATA, SCSI, RAID, and the like. In desktop computer systems, IDE hard disk drives are most common. Generally, the motherboard will control data storage and retrieval from the hard disk drive by sending commands, such as data addresses and registers, to the appropriate pins of the IDE connector on the motherboard relating to the storage of information on the hard disk. A cable connected to the IDE connector transfers those commands to the hard disk drive, which then stores or retries information accordingly. The manner in which data is stored on and retrieved from data storage devices is known to persons skilled in the art, as is the manner in which such devices are connected to the motherboard of a modern computer system.

Prior art computer systems have been susceptible to unauthorized data access. This unauthorized data access sometimes results in data theft or damage, both of which can cause severe economic hardship to the owner of the data. Unauthorized data access can occur in many different ways, may be inadvertent or maliciously motivated, and may be perpetrated either locally or over a computer network. One source of unauthorized data access is from employee computer users. For example, important data can be accessed by an employee and inadvertently written over. An employee computer user can also copy confidential data on to removable media and take it from the premises of his employer for publication or sale, potentially damaging the business interests or public image of the employer. Unauthorized data access can also be perpetrated by non-employees. For example, computers located in public areas are particularly vulnerable. Also, computer hackers can gain undetected access to data using the internet, dial-in or DSL modems, or wireless networks and writers of malicious code, such as viruses, can permanently corrupt data stored on a computer or a computer network. Unauthorized data access occurs every day and causes significant business disruption, lost productivity, and economic hardship to corporations and individuals.

Prior art computer systems use a variety of techniques to protect against unauthorized data access. These techniques are generally based on either hardware or software. Examples of software techniques include password protection for some or all computer functions or data storage areas, fire walls, virus protection software, automatic logoff options, etc. Password protection is typically applied indiscriminately at the operating system level to prevent access to the entire computer; once an employee provides his or her password, that employee typically has full read/write access to all locally stored data and often has full access to sensitive network data that is unnecessary for day-to-day job functions. Variations on password protection include making inaccessible to certain user levels a selected drive partition or network drive; however there is no easily configurable basis upon which to specify whether a particular user has full read/write access, read only access, no access, etc. In addition, software based methods may be easily circumvented by computer hackers or other unscrupulous individuals. For example, hackers have created programs that will systematically search a computer or network for passwords or back doors into system operations, thus allowing the hacker complete unrestricted access to stored data. Firewall and virus protection software also suffer from limitations, must be kept updated continuously, and may be circumvented by hackers. Software based techniques are therefore incapable of providing the level of protection required in certain high-security applications.

Hardware based techniques are generally more secure than software based techniques. An example of a hardware based technique is provided in U.S. Pat. No. 5,559,993, filed Nov. 17, 1993 by Elliott, et al. and issued Sep. 2, 1996. Elliott discloses a write protection device for a computer comprising a hardware circuit with a switch connected to an internally installed circuit card which has cable connections between data storage device drives and a drive controller cable, the circuit card intercepting control lines used for drive selection and control. In one embodiment, the apparatus employs a key based switch that may be used to select from among three switch positions: both read and write enabled; read enabled, but write disabled; and, both read and write disabled. This apparatus treats all drive commands equally according to the switch position and does not scrutinize the commands passing through it in order to permit certain types of commands to pass through, regardless of the user, while filtering out other commands according to the user's access level. As a result, this apparatus interferes with the function of modern operating systems, which require write access to at least a portion of the hard disk drive at all times. The apparatus is applicable to a single drive only, does not support multiple drive partitions, is not software configurable to permit varying degrees of access for multiple users, and is inapplicable to network environments.

Therefore, there is a need in the art for a method and apparatus that will secure a data storage device against unauthorized access, either locally or remotely, particularly when the individual user of the computer is away from his or her machine.

There also is a need in the art for a hardware based method and apparatus for selectively filtering read/write commands in order to block access to certain types of data or to certain portions of a data storage device, such as a hard disk drive, according to the identity of individual users.

There also is a need in the art for a low cost high speed system that will provide configurable access to a data storage device and that is more difficult to circumvent than prior art software or hardware based techniques.

There is also a need in the art for a system that meets the above needs that is applicable in a network environment.

One object of the present invention is to provide a low cost, high speed method and apparatus for filtering read/write commands in order to block access to areas of a data storage device, such as a hard disk drive.

Another object of the present invention is to provide customizable levels of access to data according to a user-defined configuration table.

Still another object of the present invention is to provide an apparatus that locally secures unauthorized access to data stored on the data storage device.

Still another object of the present invention is to prevent unauthorized access to a data storage device via identification and authorization of the individual user to the individual computer.

Still another object of the present invention is to provide a quick recovery of a read/write configured portion of a data storage device by having a secured backup of that portion within a read-only configured portion of the data storage device.

Still another object of the present invention is to provide an apparatus that monitors inputs to local security devices to ascertain whether the user of the computer system is an authorized user and to block un-authorized reconfiguration of the user-defined configuration table.

Still another object of the present invention is to provide hardware based protection against hackers and computer viruses that is more difficult to circumvent than prior art systems.

Still another object of the present invention is to prevent data access in the event of removal of the data storage device from the computer system.

Still another object of the present invention is to provide a user friendly installation software package and user friendly configuration program.

Still another object of the present invention is to provide a user friendly event logging software package along with a user friendly safe backup and restore package for use on the individual computer.

Yet another object of the present invention is to fulfill the above objects in a manner that is applicable in a network environment.

### SUMMARY OF THE INVENTION

According to an aspect of the present invention, there is provided an apparatus for preventing unauthorized access to computer data, the apparatus being part of a computer system, the apparatus comprising: motherboard connection means for receiving electronic read/write commands from a motherboard of the computer system, each command issued by a user of the computer system; filter means for scrutinizing the commands and determining whether the commands are permitted to be transferred to a data storage device, or a particular portion thereof, associated with the computer system based on a pre-determined level of data access corresponding to the user; and, data storage device connection means for transferring only permitted commands to the data storage device or particular portion thereof.

According to another aspect of the invention, there is provided a method for use with a computer system to prevent unauthorized access to computer data comprising: receiving electronic read/write commands from a motherboard of the computer system, each command issued by a user of the computer system; scrutinizing the commands and determining whether the commands are permitted to be transferred to a data storage device, or a particular portion thereof, associated with the computer system based on a pre-determined level of data access corresponding to the user; and, transferring only permitted commands to the data storage device or particular portion thereof.

The method and apparatus permit selective filtering of read/write commands in order to block access to certain types of data or to certain areas of a data storage device, such as a hard disk drive. The method and apparatus permit identification of multiple individual users and are software configurable to permit customization of the level of access provided to those users. The method and apparatus may be configured to prevent data access in the event that an authorized user leaves the computer system unattended. The method and apparatus support the use of multiple drive partitions and are compatible with modern operating systems that require write access at all times for certain types of commands. The method and apparatus include event logging and permit secure backup and recovery of data. The method and apparatus prevent data theft in the event of removal of the data storage device from the computer system. The method and apparatus may be deployed over a network and are more difficult to be circumvented than prior art systems. The method and apparatus provide hardware based protection against hackers and computer viruses.

A user of the apparatus and method according to the present invention may be either a local user or a remote user. Remote users may be connected to the computer system using a network, for example, a local area network (LAN), wide area network (WAN), or an internet based network using secure techniques such as virtual private networking (VPN).

The invention may further comprise identity means for receiving a unique signal corresponding to a local user of the computer system. The unique signal may be, for example, a radio frequency signal, a biometric signal, a magnetic signal, a bar code signal, or an alphanumeric signal. The unique signal may be provided locally by the user and may be provided either directly to the apparatus or through a local security device connected to the computer system. The unique signal may be provided by a radio frequency identification (RFID) tag and the identity means may comprise an RFID transceiver, either connected to the computer system or preferably present as part of the apparatus itself.

The invention may further comprise verification means for verifying the identity of the local user by checking the signal against an electronically stored table of authorized users and for determining a corresponding level of data access to be provided to the local user from the table of authorized users. The verification means may comprise a microprocessor programmed to retrieve the table of authorized users from electronic storage, cross-reference the unique signal with signals in the table corresponding to authorized users and their respective level of data access, and thereby determine the level of data access of the local user. The microprocessor may perform other functions in addition to the functions of the verification means. The table of authorized users may be electronically stored in electrically erasable programmable read-only memory (EEPROM). The table of authorized users may be user-configurable via software. Permission to make changes to the table of authorized users may be included in the level of data access for a particular user.

In one embodiment, the present invention is contemplated for use by a local user or group of local users. In this case, the pre-determined level of access is the level of data access of the local user or group of users as determined from the table of authorized users. The level of data access may be determined from the table of authorized users each time a command is sent by the motherboard; alternatively, the level of data access may be electronically stored and updated periodically to account for time-outs or loss of permission due to, for example, the removal of an RFID tag from the local environment of the computer system.

The level of data access for each particular user includes information about each data storage device or portion thereof associated with the computer system. An example of a portion of a data storage device is a partition of a hard disk drive. The level of data access for each data storage device or portion thereof may be selected from the group consisting of: read/write; read only; no access; and, read/prompted write.

Each command may be parsed to determine logical block address (LBA) information in the command and the type of operation (i.e., read or write) sought to be performed on those logical block addresses. An index of LBA's, also known as a partition access table, may be used to determine which data storage device or portion thereof is sought to be accessed. If the level of data access for the particular drive or portion thereof is sufficient for the type of operation being performed, the command is permitted to pass through the filter. Otherwise, the command is blocked and an error code is returned to the user of the computer through the motherboard. The filter means may comprise a microprocessor and the microprocessor may also be programmed to perform other functions, such as the functions of the verification means.

The invention may further comprise network means for broadcasting the identity of the local user and the corresponding level of data access across a local area network associated with the computer system and for receiving an identity of a remote user and corresponding level of data access from the local area network. The network means may comprise a 10/100 network switch. The network means may be incorporated with the apparatus, or may be provided externally to the apparatus and connected thereto via cabling, etc. The network means may further comprise a network interface to permit the apparatus to communicate over the network with other instances of the apparatus. The type of information communicated may include configuration information, error codes, and/or encrypted information concerning the identity of a local or remote user and the corresponding level of data access for that user. A network availability table containing the identity and corresponding level of data access of both local users and remote users may be electronically stored as part of the invention.

In one embodiment, the network availability table may be used in determining the pre-determined level of data access corresponding to a particular local or remote user of the system. In this embodiment each apparatus continually broadcasts and receives information about the identity and level of data access of authorized users of networked computer systems. If an authorized user seeks to gain access to data on a particular computer system, the data command is passed over the network in the usual manner, through to the motherboard of the computer on which the data is located, and on to the apparatus. The identity and level of data access associated with the originator of the request is determined from the network availability table and the command is either permitted access to the data or blocked by the filter means. In the case of RFID generation of the unique signal, if an authorized user leaves the vicinity of his computer, the authorized user is removed from the network availability table and no access to network data can be obtained from that users computer terminal.

The data storage device may be a local hard disk drive, for example an IDE, serial ATA, SCSI, or RAID drive. The data storage device connection means may comprise a conventional data cable connector, such as a 40 pin IDE connector.

The apparatus may take several forms. In one embodiment, the apparatus may be an electronic computer card, such as an ISA, PCI, or PCMCIA card. In this case, the motherboard connection means comprises a conventional data cable connector, such as a 40 pin IDE connector. In another embodiment, the apparatus may be located directly on the motherboard of the computer. The apparatus may form a particular circuit board area of the motherboard or may be reduced to a single chip or group of chips that performs all of the functions of the present invention. In this case, the motherboard connection means may comprise one or more electronic circuit board traces.

The computer system may be of any suitable type, for example a desktop computer, a laptop computer, a computer workstation, or a computer server.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1 shows functional circuit blocks and their interconnections according to an embodiment of the present invention.

FIG. 2 shows functional circuit blocks and their interconnections according to another embodiment of the present invention.

FIGS. 3a and 3b are a first state diagram depicting the microprocessor actions through a command process according to the present invention.

FIG. 4 is a second state diagram depicting the microprocessor actions through a command process according to the present invention.

### DESCRIPTION OF PREFERRED EMBODIMENTS

The apparatus 14 resides between a main board and a data storage device of the computer system. In the embodiments described below, the data storage device is one or more local hard disk drives.

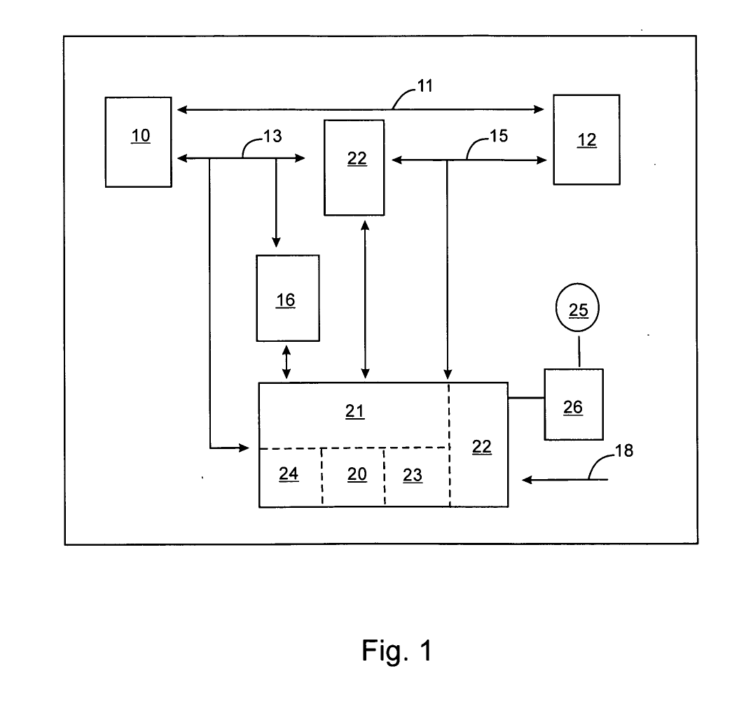

Referring to FIG. 1, read/write commands are introduced to the apparatus from the main board through motherboard data connector 10. The lower 8 bit bi-directional host bus 13 is in communication with the 16 bit bi-directional buffer 22 and the microprocessor 21.

An RFID transceiver 26 both sends and receives signals through antenna 25 in a manner that is known in the art and is used to determine the presence of a unique signal from an RFID tag. The unique signal is passed to peripheral interface 22. Unique signal inputs from optional local security devices 18 may also be provided to the peripheral interface. The RFID transceiver 26, antenna 25, peripheral interface 22 and optionally local security devices 18 make up an identity means for receiving a unique signal relating to a local user of the computer system.

The microprocessor 21 functions as part of a verification means along with EEPROM 20, which is used to electronically store a user-configurable table of authorized users. The microprocessor 21 receives a unique signal corresponding to a local user from the peripheral interface 22 and compares the signal with signals in the table of authorized users to determine the level of data access to be provided to the user. The level of data access for a particular user is broken down into the following categories for each hard disk or partition thereof of the computer system: read/write, read only, read/prompted write, and no access. For example, a computer system may have two hard disks, each with two partitions, and a given user may have full read/write access to the first drive, first partition; read only access to the first drive second partition; read/prompted write access to the second drive, first partition; and no access to the second drive, second partition. Another authorized user of that particular computer system may have a different level of data access for some or all drives or partitions. If no authorized user is present, the command is blocked and an error message is returned to the un-authorized user via motherboard connector 10.

In one embodiment, the level of data access is determined from the table of authorized users each time a command is provided. In another embodiment, the level of data access is stored in random access memory (RAM) 23 and is periodically refreshed.

One function of the apparatus 14 is to scrutinize all commands passing through it and filter out certain commands based on the user's pre-configured access level. This function is accomplished by the filter means, which comprises the microprocessor 21, FLASH memory 24, RAM 23 and EEPROM based gate array 16. Microprocessor 21 is programmed to parse each command to determine the Logical Block Address (LBA) information of the command and the type of operation (i.e., read or write) sought to be performed on those LBA's. The LBA information is compared to an index of LBA's, also known as a partition access table, internally stored in EEPROM memory 20 to determine which data storage device or portion thereof is sought to be accessed. If the user's level of data access for the particular drive or portion thereof is sufficient for the type of operation being performed, the command is permitted to pass through the EEPROM gate array 16 of the filter means. An example of a valid command is a read command intended for a logical drive or partition configured for read only or full read/write access. The command passes from the filter means to the 16 bit bi-directional buffer 22 and then to the drive data connector 12 through lower 8 bit device bus 15. Otherwise, the command is blocked from the hard disk by the EEPROM gate array 16 and the apparatus ends the command process by passing a failure code back to the main board through motherboard data connector 10. This parsing of LBAs by the filter means is performed in real-time and does not introduce delays in the data transfer process. The command is then executed by the hard disk and the data is passed back from the drive data connector 12 directly to the mother board data connector 10 through the upper 8 bit data bus 11.

When the apparatus 14 is initially configured, the partition sectors are set to read only mode. This will ensure that the operating system still sees the logical drives so that non-accessible drives do not cause lengthy access errors, but data on those drives cannot be altered. The partition access table is stored in Electrically Erasable Programmable Read Only Memory (EEPROM) 20, so that once the apparatus 14 is configured it will continue to operate every time the computer is rebooted without further user intervention. As a secondary function, the apparatus 14 also flags all illegal access attempts, so that the provided logging software can document these attempts and alert the user/system administrator.

To secure the configuration process, the apparatus 14 monitors inputs from the local security device 18 during configuration, making it possible to block invalidated or remote re-configuration. As a corollary function, the apparatus 14 can also be configured to alternate between different partition access tables dependant upon the presence/absence of a positive signal from the local security device. As an example, if RFID technology were employed and the user were to walk away from the computer, the apparatus 14 could secure all partitions on the hard disk, making it impossible to access any data on the protected drive(s).

Areas of the hard disk that are configured as read/write are still vulnerable to virus attacks. To provide a quick recovery, the apparatus and associated software enables the user to perform a secure backup (i.e. a secure priority operating system task) of an unprotected partition to a protected partition, while an authorized user is present. If required, the software will also provide a secure recovery reverting back to the data contained in the protected partition.

It should be noted that the present invention may be used on any known computer, servers, handhelds or any other device capable of saving information. In the embodiment shown an aftermarket apparatus, i.e., add-on board, card, etc., and associate software are capable of use on any known computer system, but it is contemplated to incorporate the system into the motherboard of new systems or any other type of device via any known technology. For example, the invention may be employed on desktop computers, workstations, servers, stand-alone network storage devices such as a NAS, or laptop computers. In laptop computers, the invention may take the form of a PCMCIA card or an ASIC integrated on the motherboard of the laptop computer.

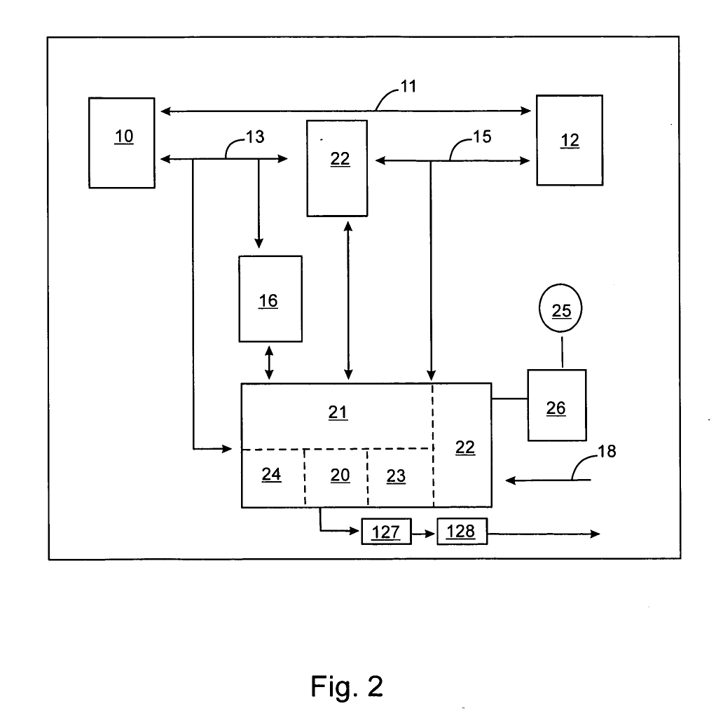

Referring to FIG. 2, another embodiment of the apparatus 14 of the present invention is shown. In addition to the features described above with reference to FIG. 1, the apparatus 14 also includes network means comprising a network interface 127 connected to a network switch 128. The network switch 128 is a conventional 10/100 based switch that permits the apparatus to be connected directly into an existing network that the computer system is part of. Network cables are connected directly into the switch 128 of the apparatus and a loop-back cable (not shown) may be used to then connect from the apparatus to the computer's existing network interface card. In this manner, normal network function is not impeded by the apparatus, but the apparatus is permitted to communicate directly over the network. The network switch 128 is connected to a network interface 127 of the apparatus. The network interface handles the overhead associated with network communications, such as TCP/IP, etc. and permits the apparatus to communicate with others of its kind that are present on the network.

The apparatus transmits over the network the identity of the local user and the corresponding level of data access. Similarly, the apparatus receives from the network information about remote authorized users on the network and their level of data access. A network availability table is created by the microprocessor 21 and is stored in RAM 23. The network availability table lists all authorized users and their level of data access. When a remote user seeks to access data from a data storage device connected to the apparatus, the apparatus checks whether that user is present on the network availability table and finds the corresponding level of data access for that user. The filter means then determines whether or not to permit the command to pass through in the usual manner using this pre-determined level of data access. In this embodiment, the level of data access of the local user is also stored in the network availability table to simplify the programming of the microprocessor; however, it is also possible to store only the identities of the remote users in the network availability table and seek identity and level of data access information for the local user from the table of authorized users in the manner described above with reference to FIG. 1.

The ATA/ATAPI-6 standard defines the following device commands and their descriptions as shown in Table 1.

The ATA/ATAPI-6 standard also defines device command registers mapped as shown in Table 2.

TABLE 1
ATA/ATAPI-6 device commands

| Acronym | Description |
|---|---|
| DD0-DD15 | Data Bus Bits 0 through 15 |
| CSEL | Cable select |
| CS0-CS1 | Chip select 0 through 1 |
| DA0-DA2 | Device Address 0 through 2 |
| DASP | Device Active or Slave Present |
| DMACK | DMA Acknowledge |
| DMARQ | DMA Request |
| INTRQ | Interrupt Request |
| DIOR | I/O Read |
| HDMARDY | DMA ready during Ultra DMA data-in bursts |
| HSTROBE | DMA strobe during Ultra DMA data-out bursts |
| IORDY | I/O Ready |
| DDMARDY | DMA ready during Ultra DMA data-out bursts |
| DSTROBE | Data strobe during Ultra DMA data-in bursts |
| DIOW | I/O Write |
| STOP | Stop during Ultra DMA data bursts |
| PDIAG | Passed Diagnostics |
| CBLID | Cable Assembly Type Identifier |
| RESET | Reset |

TABLE 2
ATA/ATAPI-6 device command registers

| CS0 | CS1 | DA2 | DA1 | DA0 | DIOR | DIOW | Description |
|---|---|---|---|---|---|---|---|
| 0 | 1 | 0 | 0 | 0 | 0 | 1 | PIO data transfer from the device (16 |
| | | | | | | | bit) |
| 0 | 1 | 0 | 0 | 0 | 1 | 0 | PIO data transfer to the device (16 bit) |
| 0 | 1 | 0 | 0 | 1 | 1 | 0 | Write data to features register (8 bit) |
| 0 | 1 | 0 | 0 | 1 | 0 | 1 | Read data from error register (8 bit) if |
| | | | | | | | command not in progress, otherwise |
| | | | | | | | status register |
| 0 | 1 | 0 | 1 | 0 | 1 | 0 | Write data to sector count register (8 |
| | | | | | | | bit) |
| 0 | 1 | 0 | 1 | 0 | 0 | 1 | Read data from sector count register |
| | | | | | | | (8 bit) if command not in progress, |
| | | | | | | | otherwise status register |
| 0 | 1 | 0 | 1 | 1 | 1 | 0 | Write data to LBA Low register (8 bit) |
| 0 | 1 | 0 | 1 | 1 | 0 | 1 | Read data from LBA Low register (8 |
| | | | | | | | bit) if command not in progress, |
| | | | | | | | otherwise status register |
| 0 | 1 | 1 | 0 | 0 | 1 | 0 | Write data to LBA Mid register (8 bit) |
| 0 | 1 | 1 | 0 | 0 | 0 | 1 | Read data from LBA Mid register (8 |
| | | | | | | | bit) if command not in progress, |
| | | | | | | | otherwise status register |
| 0 | 1 | 1 | 0 | 1 | 1 | 0 | Write data to LBA High register (8 bit) |
| 0 | 1 | 1 | 0 | 1 | 0 | 1 | Read data from LBA High register (8 |
| | | | | | | | bit) if command not in progress, |
| | | | | | | | otherwise status register |
| 0 | 1 | 1 | 1 | 0 | 1 | 0 | Write data to Device register (8 bit) |
| 0 | 1 | 1 | 1 | 0 | 0 | 1 | Read data from Device register (8 bit) |
| | | | | | | | if command not in progress, otherwise |
| | | | | | | | status register |
| 0 | 1 | 1 | 1 | 1 | 1 | 0 | Write data to Command register (8 bit) |
| 0 | 1 | 1 | 1 | 1 | 0 | 1 | Read data from Command register (8 |
| | | | | | | | bit) if command not in progress, |
| | | | | | | | otherwise status register |

The program code executed by the microprocessor 21 to achieve the functions described above will now be described. The host or main board, which is designated J1 for programming purposes, communicates to registers contained within the apparatus 14. The apparatus 14 is also connected to the data storage device, which is designated J2. A command provided by the host is sent through the connector 10 and a command designated for the data storage device is sent through the connector 12. A read/write command is transmitted by setting the address and data signals and then pulsing the appropriate DIOR (J1) or DIOW (J1) control signal. To ensure the microprocessor 21 (IC3) does not miss any I/O activity, the apparatus utilizes the EEPROM based gate array 16 (IC1) to produce an appropriately timed IORDY signal back to the host which is connected to J1. When the IORDY (J1) signal is active, the host is placed into an I/O wait state. Equation 1 defines the logic to generate the IORDY signal.
IORDY_OUT=(!REG0 & !DMACK & !CS1 & CS0 & DIOW & !DIOR & !IORDY_END & !DATAREG_{—}EN) Equation 1
# (!REG0 & !DMACK & !CS1 & CS0 & !DIOW & DIOR & !IORDY_END & !DATAREG_EN)
# (!REG0 & !DMACK & CS1 & !CS0 & DIOW & !DIOR & !IORDY_END & !DATAREG_EN)
# (!REG0 & !DMACK & CS1 & !CS0 & !DIOW & DIOR & !IORDY_END & !DATAREG_EN)
# (REG0 & !DMACK & !CS1 & CS0 & DIOW & !DIOR & !IORDY_END & DATAREG_EN)
# (REG0 & !DMACK & !CS1 & CS0 & !DIOW & DIOR & !IORDY_END & DATAREG_EN);

The IORDY_END and DATAREG_EN inputs in Equation 1 are microprocessor (IC3) outputs, which control the end of the I/O cycle and the generation of IORDY_OUT during PIO data register transfers. The REG0 input in this equation is a feedback term defined in Equation 2
REG0=!DA2 & !DA1 & !DA0; (i.e. PIO data register transfers) Equation 2

The DMACK (J1 and J2) signal is utilized here to disable the IORDY_OUT signal during DMA data transfers, which is a device controlled function.

During an I/O write cycle, the gate array logic produces an INT0 signal, defined in Equation 3 below, to interrupt the microprocessor (IC3).
INT0=(!REG0 & !DMACK & !CS1 & CS0 & DIOW & !DIOR & !IORDY_END & !DATAREG_{—}EN) Equation 3
# (!REG0 & !DMACK & CS1 & !CS0 & DIOW & !DIOR & !IORDY_END & !DATAREG_EN)
# (REG0 & !DMACK & !CS1 & CS0 & DIOW & DIOR & !IORDY_END & DATAREG_EN);

During an I/O read cycle, the gate array logic produces an INT1 signal, defined in Equation 4 below, to interrupt the microprocessor (IC3).
INT1=(!REG0 & !DMACK & !CS1 & CS0 & !DIOW & DIOR & !IORDY_END & !DATAREG_{—}EN) Equation 4
# (!REG0 & !DMACK & CS1 & !CS0 & !DIOW & DIOR & !IORDY_END & !DATAREG_EN)
# (REG0 & !DMACK & !CS1 & CS0 & !DIOW & DIOR & !IORDY_END & DATAREG_EN);

To enable the microprocessor (IC3) to control the device's bus, the gate array 16 is utilized to generate the BUSDRV_OE signal, defined in Equation 5 below, which controls the output enable of the 16 bit bi-directional buffer 22 (IC2).
BUSDRV_OE=DMACK # BUS_EN; Equation 5

A contemplated I/O write cycle sequence from host 10 (J1) to device 12 (J2) includes at least the following steps:
1. Before any I/O operations are performed, the microprocessor 21 (IC3) initializes the IORDY_END inactive, the DATAREG_EN inactive and the BUS_EN active.
2. The host 10 (J1) sets the address (CS0-CS1, DA0-DA2) and data (DD0-DD7).
3. The device 12 (J2) receives the address (CS0-CS1, DA0-DA2) and data (DD0-DD7) through the 16 bit bi-directional buffer 22 (IC2).
4. The host 10 (J1) sets the DIOW signal active.
5. The device 12 (J2) receives the DIOW signal through the 16 bit bi-directional buffer 22 (IC2).
6. The gate array 16 (IC1) de-activates the IORDY_OUT to place the host 10 (J1) into a wait state.
7. The gate array 16 (IC1) activates the INT0 to interrupt the microprocessor 21 (IC3).
8. The microprocessor 21 (IC3) takes action dependant upon the information contained in this and previous I/O cycles. This process is described in detail, below.
9. The microprocessor 21 (IC3) activates the IORDY_END signal so that the gate array 16 (IC1) de-activates the IORDY OUT signal, which allows the host 10 (J1) to finish the I/O cycle.
10. The host 10 (J1) de-activates the DIOW signal.

A contemplated I/O read cycle sequence from device 12 (J2) to host 10 (J1) includes at least the following steps:
1. Before any I/O operations are performed, the microprocessor 21 (IC3) initializes the IORDY_END inactive, the DATAREG_EN inactive and the BUS_EN active.
2. The host 10 (J1) sets the address (CS0-CS1, DA0-DA2).
3. The device 12 (J2) receives the address (CS0-CS1, DA0-DA2) through the 16 bit bi-directional buffer 22 (IC2).
4. The host 10 (J1) sets the DIOR signal active.
5. The device 12 (J2) receives the DIOR signal through the 16 bit bi-directional buffer 22 (IC2).
6. The gate array 16 (IC1) de-activates the IORDY_OUT to place the host (J1) into a wait state.
7. The gate array 16 (IC1) activates the INT1 to interrupt the microprocessor 21 (IC3).
8. The microprocessor 21 (IC3) takes action dependant upon the state of the complete command process. This process is described in detail, below.
9. Either the device 12 (J2) through the 16 bit bi-directional buffer 22 (IC2) or the microprocessor 21 (IC3) places the read data onto the host 10 (J1) DD0-DD7 pins.
10. The microprocessor 21 (IC3) activates the IORDY_END signal so that the gate array 16 (IC1) de-activates the IORDY_OUT signal, which allows the host 10 (J1) to finish the I/O cycle.
11. The host 10 (J1) de-activates the DIOR signal.

The host 10 commands the device 12 utilizing the registers defined in Table 2. Typically, a complete command (28 bit LBA) sequence includes at least the following device register action:
1. The host 10 selects the appropriate device by writing to the device register.
2. The host 10 reads the status register to ensure the device is selected and ready.
3. The host 10 writes to the sector count register.
4. The host 10 writes LBA bits 0-7 to the LBA Low register.
5. The host 10 writes LBA bits 8-15 to the LBA Mid register.
6. The host 10 writes LBA bits 16-23 to the LBA High register.
7. The host 10 writes LBA bits 24-27 to the device register.
8. The host 10 reads the status register to ensure the device 12 is ready.
9. The host 10 writes the command to the command register.
10. Dependant upon the command type the host 10 waits for the device 12 to complete the operation.

This design ultimately places the microprocessor 21 (IC3) in control of all I/O operations between the host 10 (J1) and the device 12 (J2). Hence, the microprocessor 21 (IC3) monitors each command step so that when a complete command is transferred, it can:
1. Use the LBA information and command type to decide on the validity of the command and either:
   a. transfer the command to the device 12; or,
   b. block the command to the device 12 and report a failure to the host 10.
2. Use the LBA information and command type to determine if the command represents configuration data destined to or from the apparatus 14 and either:
   a. read the data from the host 10 and place it into its configuration tables; or,
   b. write data back to the host 10, which represents its current status.

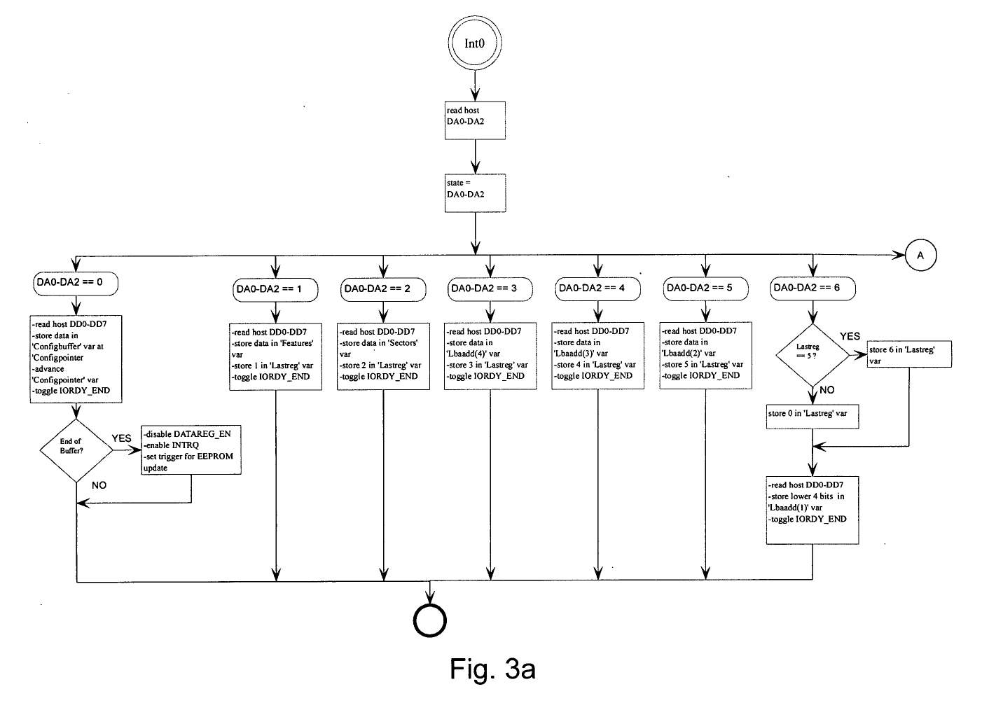

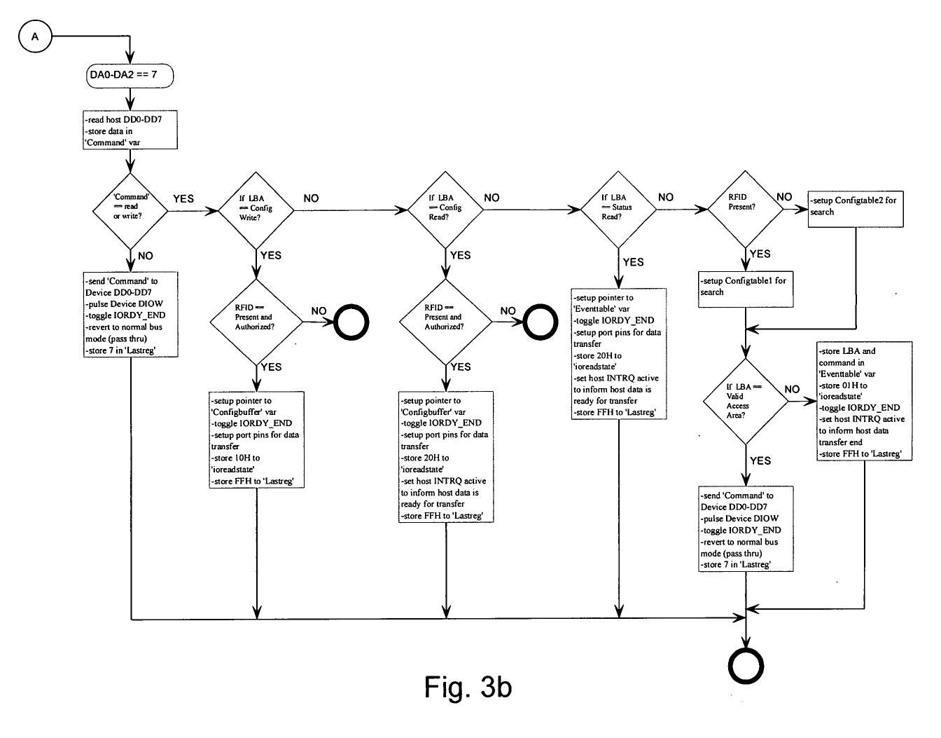

The state diagrams in FIGS. 3a, 3b, 4 and 5 depict the microcontroller's actions throughout one contemplated command process. The firmware code that defines the state diagrams is stored within the microprocessor 21 (IC3) internal FLASH memory 24. The microprocessor 21 (IC3) utilizes its EEPROM memory 20 to store the configuration tables and its RAM 23 for temporary variable storage during execution of the firmware.

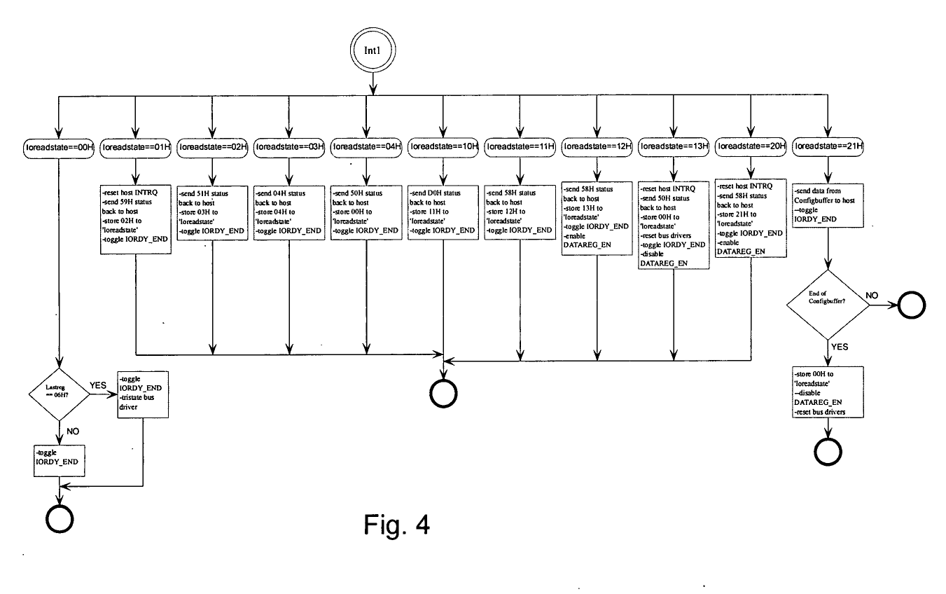

With the apparatus 14 installed the host command sequence will not change but the microprocessor 21 may react as follows:
1. The host 10 selects the appropriate device 12 by writing to the device register.
   a. The microprocessor 21 stores the device register contents as shown in FIG. 3a through the ‘DA0-DA2==6’ path.
2. The host 10 reads the status register to ensure the device 12 is selected and ready.
   a. The microprocessor 21 allows the device 12 to respond with the appropriate status as shown in FIG. 4 through the loreadstate==00H path.
3. The host 10 writes to the sector count register.
   a. The microprocessor 21 stores the sector count contents as shown in FIG. 3a through the ‘DA0-DA2==2’ path.
4. The host 10 writes LBA bits 0-7 to the LBA Low register.
   a. The microprocessor 21 stores the LBA Low contents as shown in FIG. 3a through the ‘DA0-DA2==3’ path.
5. The host 10 writes LBA bits 8-15 to the LBA Mid register.
   a. The microprocessor 21 stores the LBA Mid contents as shown in FIG. 3a through the ‘DA0-DA2==4’ path.
6. The host 10 writes LBA bits 16-23 to the LBA High register.
   a. The microprocessor 21 stores the LBA High contents as shown in FIG. 3a through the ‘DA0-DA2==5’ path.
7. The host 10 writes LBA bits 24-27 to the device register.
   a. The microprocessor 21 stores the LBA bits 24-27 contents as shown in FIG. 3a through the ‘DA0-DA2==6’ path.
8. The host 10 reads the status register to ensure the device 12 is ready.
   a. The microprocessor 21 allows the device 12 to respond with the appropriate status as shown in FIG. 4 through the loreadstate==00H path.
9. The host 10 writes the command to the command register.
   a. The microprocessor 21 follows the ‘DA0-DA2==7’ path in FIG. 3b to validate the command based upon the LBA address stored previously.
      I. If this command type is valid at the given LBA, the command is relayed to the device 12 and the data transfer process is allowed to proceed.
      ii. If this command type is invalid at the given LBA, the command is not relayed to the device 12 and the microprocessor 21 follows the paths shown in FIG. 4 through ‘loreadstate==01H’, ‘loreadstate==02H’, ‘loreadstate==03H’ and ‘loreadstate==04’. Each of these states may be triggered by the host 10 attempting to carry out the command while reading an error status from the microprocessor 21 rather than the device 12 itself. Hence the device 12 does not see the command and the host 10 is informed of an error.

The apparatus contains a RFID transceiver 26 interface, which is based on single chip solution (IC4). The microprocessor 21 (IC3) controls the RF field generated by IC4 and receives the RFID tag responses during idle process times. During the installation and re-configuration phases of the apparatus, authorized RFID tag numbers are stored into the microprocessor's EEPROM memory 20. As shown in FIG. 3b, all operations performed on the device 12 must also be authorized by the presence of a valid RFID. This ensures that all remote access to the PC's hard disk 12 is first verified by two security measures; authorized command type to the given area of the hard disk 12 and an authorized user is present during the operation.

To support operations that do not have RFID technology, the apparatus also has inputs for magnetic stripe access card readers, barcode access card readers, physical key switches or any other known locking device. In this mode of operation, the apparatus only verifies the presence of the security device during initial startup. During normal operation the security device does not need to be continuously present, and the apparatus only supports one configuration table

The apparatus includes four software programs within a contemplated package. However, any other number of program modules or apparatuses may also be used. The features of the four software programs are described below:
1. A user-friendly installation software package that guides the user through the installation process, copying required files, safely re-partitioning the hard disk, configuring the apparatus and configuring the support software packages. This software package may include but is not limited to the following features:
   a. Each step of the installation process guides the user through options available
   b. Hard disk is safely re-partitioned to support the requested configuration.
   c. All support software package options will setup automatically.
   d. Optional “quick standard” configuration.
   e. Support for one or more Operating Systems
   f. Automatic update of the apparatus firmware.
2. A user-friendly configuration program that allows the user to modify the current configuration of the apparatus. This software package may include but is not limited to the following features:
   a. Current logical hard disk configuration is automatically compared to the apparatus configuration to ensure safe modifications.
   b. Point and click user interface.
   c. Automatic update of the apparatus configuration table.
   d. Support for one or more Operating Systems
3. A user-friendly event logging software package that allows the user to monitor and be aware of any apparatus problems or illegal attempts to gain access to protected areas of the hard disk. This software package may include but is not limited to the following features:
   a. Executed in the background constantly monitoring the status of the apparatus.
   b. Automatic alerts to the user
   c. Configurable alert levels
   d. Event log is stored in a safe area of the hard disk.
   e. Event log viewer supports column sorting and grouping
   f. User-friendly event log printing options.
   g. Support for one or more Operating Systems
4. A user-friendly safe backup and restore software package that allows the user to store the contents of the logical working drive into a safe area of the hard disk. This software package may include but is not limited to the following features:
   a. User-friendly setup of full or partial backup capabilities.
   b. Backup and Restore processes are executed as exclusive tasks.
   c. Support for one or more Operating Systems.

Once the apparatus and support software is installed and configured, the product as a whole offers the user protection against viruses, malicious data alteration, data theft, unauthorized access, etc.

The apparatus optionally includes a feature specifically adapted to prevent data theft in the event of removal of the hard drive from the computer system. Upon initial configuration the MAC address of the computer's network interface card (NIC) is read by the apparatus along with the master boot record (MBR) of the hard drive and both are placed in EEPROM memory 20. The MBR is then moved to a different location on the hard drive and that location is also stored in EEPROM memory 20. The new location is randomly determined and the apparatus configures the location to be secure, preventing all access to the location other than read/write access needed by the operating system for normal operation. Upon booting the computer system, the apparatus confirms that the MAC address of the computer is still the same, assumes that it is still located in the same computer as when it was initially configured, and permits the operating system to access data stored in the MBR, such as information on the location of partitions and the location of the first and last sectors of the hard disk. The computer then boots as normal. If the MAC address is different, the apparatus concludes it has been moved to a different computer, restricts booting of the computer, and prevents access to all data. If the hard drive is removed from the computer and placed in another computer, that second computer searches for the MBR in its original location and, not finding it, cannot determine where data is stored on the drive. No data can be recovered from the hard drive. If the hard disk is placed in a new computer with a new NIC and a newly configured version of the apparatus, the new apparatus still cannot access data on the drive as it does not know the location of the MBR. The copy of the MBR stored in EEPROM memory 20 is a backup copy in case corruption of the MBR occurs and is periodically updated by the apparatus to allow a secure recovery of the hard drive if needed. The functions of this embodiment can also be reduced to a chip that is placed on the hard drive itself to help further secure the hard drive in the event of removal from the computer system.

Another apparatus function is to store encrypted ID's in an un-accessible area of the hard disk, which can be utilized within a network environment to provide authorized remote access to hard disks protected by the apparatus. Support for external biometric input devices for user authentication is implemented by connecting the desired local security device to the computer system. An example of a biometric input local security device is a fingerprint mouse. There may also be a tracking feature, such as IP address logging, incorporated in the present invention to allow the computer user to determine where any unauthorized access attempts originated from.

To better explain the function of the invention from the viewpoint of a user of the computer system, the following examples are provided for a typical file read operation, such as accessing a document in a word processing package using File Open, both without the apparatus installed and with the apparatus installed.

### EXAMPLE 1

### File Open Without Apparatus (Prior Art)

1. While working in a word processing package (for example, Microsoft Word®) the user selects File Open.

2. The word processing package instructs the operating system (for example, Microsoft Windows®) to read all of the directory entries for the selected drive.

3. The operating system instructs the motherboard to obtain the directory entries.

4. The motherboard issues a command to the hard disk to read the required sectors from the file system table (for example, the File Access Table (FAT)) of the hard disk through a data cable connecting the motherboard and the hard disk.

5. The hard disk converts the sector request into cylinder/head information, retrieves the data, and transmits the data to the motherboard through the data cable.

6. The motherboard places the data in Random Access Memory (RAM) on the motherboard.

7. The operating system passes the data to the word processing package, which formats the data into a file open dialog.

8. The user is then expected to select the file from the list and click the open button.

9. The word processing package instructs the operating system to read the requested file.

10. Utilizing the directory entry, the operating system instructs the motherboard to read all of the Logical Block Addresses (LBA's) associated with the file.

11. The motherboard issues a command to the hard disk to read the LBA's through the data cable.

12. The hard disk converts the LBA's into cylinder/head information, retrieves the data at the requested LBA's, and transmits the data to the motherboard through the data cable.

13. The motherboard places the data in RAM on the motherboard.

14. The operating system passes the data to the word processing package, which formats the data to display the contents of the file in a user readable format

### EXAMPLE 2

### File Open with Apparatus (Invention)

The following pre-requisites are assumed to have been completed: the apparatus has been previously installed and configured by the system administrator; and, the user has an authorized RFID in proximity to the computer system.

1. While working in a word processing package (for example, Microsoft Word®) the user selects File Open.

2. The word processing package instructs the operating system (for example, Microsoft Windows®) to read all of the directory entries for the selected drive.

3. The operating system instructs the motherboard to obtain the directory entries.

4. The motherboard issues a command to the hard disk to read the required sectors from the file system table (for example, the File Access Table (FAT)) of the hard disk through a motherboard data cable connecting the motherboard and the apparatus.

5. The apparatus compares the command with a level of data access for the user, particularly the level of data access as it relates to the hard disk or partition on which the data is stored. The level of data access is determined from either the table of authorized users or the network availability table. The apparatus either validates the command and permits the command to pass through to the hard disk through the drive data cable, or blocks the command and returns an error code to the motherboard through the motherboard data cable.

6. Assuming that the command is validated by the apparatus, the hard disk converts the sector request into cylinder/head information, retrieves the data, and transmits the data to the apparatus through the drive data cable.

7. The apparatus passes the data through to the motherboard data cable using the 16 bit data bus.

8. The motherboard places the data in Random Access Memory (RAM) on the motherboard.

9. The operating system passes the data to the word processing package, which formats the data into a file open dialog.

10. The user is then expected to select the file from the list and click the open button.

11. The word processing package instructs the operating system to read the requested file.

12. Utilizing the directory entry, the operating system instructs the motherboard to read all of the Logical Block Addresses (LBA's) associated with the file.

13. The motherboard issues a command to the hard disk to read the LBA's through the motherboard data cable.

14. The apparatus compares the command with a level of data access for the user, particularly the level of data access as it relates to the hard disk or partition on which the data is stored. The level of data access is determined from either the table of authorized users or the network availability table. The apparatus either validates the command and permits the command to pass through to the hard disk through the drive data cable, or blocks the command and returns an error code to the motherboard through the motherboard data cable.

15. Assuming that the command is validated by the apparatus, the hard disk converts the LBA's into cylinder/head information, retrieves the data at the requested LBA's, and transmits the data to the apparatus through the drive data cable.

16. The apparatus passes the data through to the motherboard data cable using the 16 bit data bus.

17. The motherboard places the data in RAM on the motherboard.

18. The operating system passes the data to the word processing package, which formats the data to display the contents of the file in a user readable format.

While it may be apparent that the preferred embodiment of the invention disclosed is well calculated to fill benefits, objects or advantages of the present invention, it should be appreciated that the invention is susceptible to modification, variations and change without departing from the proper scope of the invention as shown.

Other advantages which are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. An apparatus for preventing unauthorized access to computer data, the apparatus being part of a computer system, the apparatus comprising:
a) motherboard connection means for receiving electronic read/write commands from a motherboard of the computer system, each command issued by a user of the computer system;
b) filter means for scrutinizing the commands and determining whether the commands are permitted to be transferred to a data storage device, or a particular portion thereof, associated with the computer system based on a pre-determined level of data access corresponding to the user;
c) data storage device connection means for transferring only permitted commands to the data storage device or particular portion thereof.

2. An apparatus according to claim 1, wherein the apparatus further comprises identity means for receiving a unique signal corresponding to a local user of the computer system.

3. An apparatus according to claim 2, wherein the apparatus further comprises verification means for verifying the identity of the local user by checking the signal against an electronically stored table of authorized users and for determining a corresponding level of data access to be provided to the local user from the table of authorized users.

4. An apparatus according to claim 3, wherein in step b) the pre-determined level of data access is the level of data access of the local user from the table of authorized users.

5. An apparatus according to claim 3, wherein the apparatus further comprises network means for broadcasting the identity of the local user and the corresponding level of data access across a local area network associated with the computer system and for receiving an identity of a remote user and corresponding level of data access from the local area network.

6. An apparatus according to claim 5, wherein the apparatus further comprises an electronically stored network availability table containing the identity and corresponding level of data access of both local users and remote users.

7. An apparatus according to claim 6, wherein in step b) the pre-determined level of data access is the level of data access of the local or remote user from the network availability table.

8. An apparatus according to claim 1, wherein the apparatus is an electronic computer card and wherein the motherboard connection means comprises a data cable connector.

9. An apparatus according to claim 1, wherein the apparatus is located on the motherboard and wherein the motherboard connection means comprises one or more electronic circuit board traces.

10. An apparatus according to claim 2, wherein the unique signal is a radio frequency signal, a biometric signal, a magnetic signal, a bar code signal, or an alphanumeric signal provided by the user through a local security device.

11. An apparatus according to claim 2, wherein the unique signal is a radio frequency identification (RFID) signal and wherein the identity means comprises an RFID transceiver.

12. An apparatus according to claim 3, wherein the table of authorized users is user-configurable via software.

13. An apparatus according to claim 3, wherein the verification means comprises a microprocessor programmed to retrieve the table of authorized users from electronic storage, cross-reference the unique signal with signals in the table corresponding to authorized users and their respective level of data access, and thereby determine the level of data access of the local user.

14. An apparatus according to claim 1, wherein the level of data access for each data storage device or portion thereof is selected from the group consisting of:
read/write; read only; no access; and, read/prompted write.

15. An apparatus according to claim 1, wherein the filter means comprises a microprocessor programmed to: determine which data storage device or portion thereof is sought to be accessed by the command; check the level of data access of the user for the particular data storage device or portion thereof and for the type of operation being performed by the command; and, permit the command to be transferred to the data storage device or portion thereof if the level of data access is sufficient for the type of operation being performed.

16. An apparatus according to claim 1, wherein the data storage device is a local hard disk drive and the data storage device connection means comprises a data cable connector.

17. An apparatus according to claim 1, wherein the computer system is a desktop computer, a laptop computer, a computer workstation, or a computer server.

18. A method for use with a computer system to prevent unauthorized access to computer data comprising:
a) receiving electronic read/write commands from a motherboard of the computer system, each command issued by a user of the computer system;
b) scrutinizing the commands and determining whether the commands are permitted to be transferred to a data storage device, or a particular portion thereof, associated with the computer system based on a pre-determined level of data access corresponding to the user;
c) transferring only permitted commands to the data storage device or particular portion thereof.

19. A method according to claim 18, wherein the method further comprises receiving a unique signal corresponding to a local user of the computer system.

20. A method according to claim 19, wherein the method further comprises verifying the identity of the local user by checking the signal against an electronically stored table of authorized users and determining a corresponding level of data access to be provided to the user from the table of authorized users.

21. A method according to claim 20, wherein in step b) the pre-determined level of data access is the level of data access of the local user from the table of authorized users.

22. A method according to claim 20, wherein the method further comprises broadcasting the identity of the local user and the corresponding level of data access across a local area network associated with the computer system and receiving an identity of a remote user and corresponding level of data access from the local area network.

23. A method according to claim 22, wherein the method further comprises electronically storing a network availability table containing the identity and corresponding level of data access of both local users and remote users.

24. A method according to claim 23, wherein in step b) the pre-determined level of data access is the level of data access of the local or remote user from the network availability table.
